(19) United States
(12) Patent Application Publication
(10) Pub. No.: US 2026/0286891 A1
(43) Pub. Date: Sep. 24, 2026

(54) SYSTEM AND METHOD FOR COOLING AN AIRCRAFT TURBINE ENGINE

(71) Applicant: SAFRAN AIRCRAFT ENGINES, Paris (FR)

(72) Inventors: Jérémy Edmond FERT, MOISSY-CRAMAYEL (FR); Bruno Robert GAULLY, MOISSY-CRAMAYEL (FR); Aly DIALLO, MOISSY-CRAMAYEL (FR)

(21) Appl. No.: 19/475,478

(22) PCT Filed: Apr. 11, 2024
(86) PCT No.: PCT/EP2024/059816

§ 371 Date: Oct. 15, 2025

(30) Foreign Application Priority Data
Apr. 26, 2023 (FR) FR2304247

(51) Int. Cl. F02C 7/14; F02C 3/22; F02C 7/16

(52) U.S. Cl. CPC F02C 7/14; F02C 3/22; F02C 7/16; F05D 2260/205; F05D 2260/213

(57) ABSTRACT

A system for cooling a gas turbine engine, which system includes a first cooling circuit configured to inject, into the gas turbine, a first air flow from the compressor, a second cooling circuit configured to inject, into the gas turbine, a second air flow from the compressor, a loop for circulating a heat transfer fluid, a first heat exchanger configured to cool the first air flow during circulation of the heat transfer fluid, a second heat exchanger configured to cool the second air flow during circulation of the heat transfer fluid, and a third heat exchanger configured to cool the heat transfer fluid from the circulation of a cryogenic fuel flow. The heat transfer fluid circulating in the second heat exchanger, the first heat exchanger and the third heat exchanger successively.

### TECHNICAL FIELD

The present invention relates to the field of aircraft turbine engines and more particularly to the cooling of an aircraft turbine engine gas turbine.

Climate change is a major concern for many legislative and regulatory bodies around the world. Various restrictions on carbon emissions have been, are being or will be adopted by different countries. In particular, an ambitious standard applies both to new types of aircrafts and to those already in circulation, requiring the implementation of technological solutions so as to bring them into line with current regulations. For several years now, the civil aviation has been working to help combat climate change.

The technological research efforts have already led to very significant improvements in the environmental performance of the aircrafts. The Applicant takes into account the impacting factors in all phases of design and development to obtain aeronautical elements and products that consume less energy, are more environmentally friendly and whose integration and use in civil aviation have moderate environmental consequences with the aim of improving the energy efficiency of the aircrafts.

Consequently, the Applicant is constantly working to reduce its negative impact on the climate through the use of virtuous development and manufacturing methods and processes that minimize greenhouse gas emissions as much as possible in order to reduce the environmental footprint of its business.

This sustained research and development work concerns new generations of aircraft engines, the lightening of aircraft, in particular through the materials used and lighter on-board equipment, the development of the use of electrical technologies for propulsion and, as an essential complement to technological progress, aeronautical biofuels.

To this end, the invention is the result of technological research aimed at significantly improving the aircraft performance and, in this sense, contributes to reducing the environmental impact of the aircrafts. To this end, the invention relates to the field of aircrafts comprising a turbine engine supplied by a fuel (more generally referred to as fuel) stored in a cryogenic tank.

In a known way, with reference to [FIG. 1], an aircraft comprises a propulsion assembly 1 to allow it to move. The propulsion assembly 1 extends longitudinally along an axis X and is configured to contribute to the propulsion of the aircraft by accelerating a flow of air A which circulates from upstream to downstream. In this document, the terms “upstream” and “downstream” refer to the longitudinal axis X which extends from upstream to downstream. To do this, the propulsion assembly 1 comprises a fan 2 configured to generate the air flow A to supply a gas turbine engine 3 and allow the aircraft to be propelled.

As is known, the gas turbine engine 3 comprises, in succession along the longitudinal axis X, at least one compressor 31, a combustion chamber 32 and at least one gas turbine 33. The compressor 31 is configured to receive the air flow A from the fan 2 and compress it supply the combustion chamber 32. An exhaust air flow AE, resulting from the combustion, in the combustion chamber 32, between the fuel and the compressed air flow, drives the gas turbine 33 in rotation which drives the compressor 31 with the fan 2.

In practice, at the outlet of the combustion chamber 32, the exhaust air flow AE has a very high temperature, generally of the order of 1700° C. (2000K). Such a temperature makes it necessary to cool the gas turbine 33 which receives the exhaust air flow AE.

In order to cool the gas turbine 33, it is known to provide a cooling circuit CD which takes part of the compressed air flow A, hereinafter “cooling air flow AR”, from the compressor 31 and injects it into the gas turbine 33. The cooling air flow AR, coming from the compressor 31, has a lower temperature than the exhaust air flow AE, which ensures an effective cooling.

With reference to [FIG. 1], in order to cool the gas turbine 33 more efficiently, a heat exchanger 6 is known to be provided in the cooling circuit CD in order to supply frigories to the cooling air flow AR. It has been proposed to circulate in the heat exchanger 6 a fuel flow Q, in particular hydrogen, which is stored at a temperature of the order of −253 to −251° C. (20 to 22 Kelvin) in a cryogenic tank R of the aircraft. The fuel Q then represents an important cold source that may bring frigories to the cooling air flow AR.

In practice, such an architecture may present risks of damage to the gas turbine engine 2 in the event of a leak in the heat exchanger 6. Fuel may therefore be conducted by the cooling circuit close to the gas turbine, which is a hot area of the gas turbine engine 2.

The invention thus aims to eliminate at least some of these disadvantages by proposing a simple and effective system for cooling a gas turbine while guaranteeing optimum safety in the gas turbine engine.

### PRESENTATION OF THE INVENTION

The invention relates to a system for cooling a gas turbine engine for an aircraft, the gas turbine engine being configured to be supplied by a fuel stored in at least one cryogenic tank and comprising, in succession along a longitudinal axis, at least one compressor, a combustion chamber and at least one gas turbine, a fuel flow circulating in a fuel circuit mounted between the cryogenic tank and the combustion chamber of the gas turbine engine, the cooling system comprising:
a first cooling circuit configured to take a first air flow from the compressor and inject it into the gas turbine,
a second cooling circuit configured to take a second air flow from the compressor and inject it into the gas turbine,
at least one circulation loop for circulating a heat transfer fluid,
a first heat exchanger, mounted in the first cooling circuit and in the circulation loop, configured to cool the first air flow during the circulation of the heat transfer fluid,
a second heat exchanger, mounted in the second cooling circuit and in the circulation loop, configured to cool the second air flow during the circulation of the heat transfer fluid, and
a third heat exchanger, mounted in the circulation loop, and configured to cool the heat transfer fluid from the circulation of the fuel flow,
the circulation loop being configured to circulate the heat transfer fluid successively through the second heat exchanger, the first heat exchanger and the third heat exchanger.

Advantageously, the cooling system according to the invention allows the gas turbine to be cooled efficiently and safely from air flows taken from the compressor. The heat transfer fluid loop allows to eliminate any risk of air and fuel mixing, ensuring a high level of safety.

In addition, two cooling circuits allow to ensure that the gas turbine is cooled even in the event of failure of one of them, for example. A modulation is also possible to obtain a compromise between the efficiency and the desired and optimum cooling.

The air for cooling the gas turbine is advantageously cooled effectively, via the heat transfer fluid loop, by the fuel from a cryogenic tank, which represents a significant source of cold. In this document, the term “fuel” refers to a fuel configured to be burnt in the combustion chamber of a gas turbine engine.

A series connection allows to cool the first flow of hot air from the compressor and then the second air flow, while heating the heat transfer fluid which may then advantageously heat the fuel flow. By heating the fuel flow, the heat transfer fluid is effectively cooled, returning to the loop to cool the air flow. The cascade cooling allows rapidly to reduce the temperature difference. In addition, as the fuel flow is heated by the heat transfer fluid, there is no need for an independent conditioning system, which reduces the overall dimension and the weight of the aircraft and therefore limits greenhouse gas emissions and the impact on the environment.

Preferably, the compressor of the gas turbine engine comprising a low-pressure stage and a high-pressure stage, configured to compress the incoming air flow to supply the combustion chamber, the first air flow is a low-pressure air flow coming from the low-pressure stage and the second air flow is a high-pressure air flow coming from the high-pressure stage. This type of embodiment makes it advantageous to first cool the air flow from the high-pressure compressor, which is over-compressed and therefore hotter, and then the air flow from the low-pressure compressor, which is cooler and requires less cooling.

In one embodiment, each cooling circuit comprises a first circulation duct and a second circulation duct mounted in parallel in the first cooling circuit and in the second cooling circuit respectively. Each cooling circuit thus comprises redundant circulation ducts, which makes it advantageous to ensure the circulation of the first air flow and the second air flow in the cooling circuits, allowing to guarantee an effective cooling of the turbine, even in the event of a fault in one of the circulation ducts, and therefore a high level of safety.

In one embodiment:
the first cooling circuit comprises a first controllable distribution member configured to regulate the flow rate of the first air flow between the first circulation duct and the second circulation duct,
the second cooling circuit comprises a second controllable distribution member configured to regulate the flow rate of the second air flow between the first circulation duct and the second circulation duct, and
the cooling system comprises a computer configured for allowing a circulation of the first air flow only in one of the first circulation duct or the second circulation duct of the first cooling circuit and a circulation of the second air flow only in one of the first circulation duct or the second circulation duct of the second cooling circuit.

The two air flows coming from the compressor are thus not allowed to circulate simultaneously in the two circulation ducts of the same cooling circuit, which allows to offer redundancy of the cooling circuits, thus allowing to secure the cooling of the gas turbine even in the event of damage to one of the circulation ducts, for example. The gas turbine may also advantageously be cooled by a flow of air from the compressor without penalizing the gas turbine engine by taking a limited fraction of the compressed air flow. It is advantageous to use the distribution member to regulate the flow rate in each cooling circuit. Thanks to the distribution members, it is also possible, for example, to allow an operation in degraded mode in the event of damage to one of the elements of the cooling circuits, while ensuring that the turbine is cooled to a minimum, so as to guarantee high levels of safety.

In one embodiment, the cooling system comprising at least a first member for measuring the flow rate of the first air flow in each circulation duct of the first cooling circuit and a second member for measuring the flow rate of the second air flow in each circulation duct of the second cooling circuit, the computer is configured to prevent the circulation of the first air flow, or the second air flow respectively, in one of the circulation ducts when the first flow rate measuring member, or the second flow rate measuring member respectively, measures a flow rate below a predetermined flow rate threshold in said circulation duct. This guarantees the safety in the cooling system by allowing a leak to be detected without affecting the circulation of a cooled air. The gas turbine may continue to be cooled thanks to the faultless cooling circuit. In fact, the computer is configured so that, when the first distribution member prevents the first air flow from circulating in the first circulation duct as a result of the first measuring member measuring a flow rate that is too high, it allows the first air flow to circulate in the second circulation duct. The same applies to the second cooling circuit.

Alternatively, the cooling system comprises at least a first member for measuring the temperature of the first air flow in each circulation duct of the first cooling circuit and a second member for measuring the temperature of the second air flow in each circulation duct of the second cooling circuit. The computer is configured to prevent the first air flow, or the second air flow, from circulating in one of the circulation ducts when the first temperature measurement member, or the second temperature measurement member, measures a temperature above a predetermined temperature threshold. As the pressure increases, so does the temperature. Advantageously, the computer controls the closure of the cooling circuit circulation duct if the temperature is too high, indicating a fault in said circulation duct, which allows the cooling circuit to continue to operate in complete safety.

In one embodiment, the gas turbine engine comprising an oil circuit configured to circulate a flow of lubricating oil via the compressor so as to lubricate and cool it, the cooling system comprises a fourth heat exchanger, mounted in the circulation loop for the heat transfer fluid and in the oil circuit, configured to cool the oil flow during the circulation of the heat transfer fluid. The single heat transfer fluid circulation loop may thus advantageously cool the gas turbine, heat the fuel flow for injection and cool the lubricating oil.

In one embodiment, the gas turbine engine is configured to be supplied by a first fuel flow circulating in a first fuel circuit and by a second fuel flow circulating in a second fuel circuit stored in at least one cryogenic tank,
the cooling system comprising at least a first circulation loop for a first heat transfer fluid and a second circulation loop for a second heat transfer fluid,
the first heat exchanger, the second heat exchanger and the third heat exchanger being mounted in the first circulation loop,
the cooling system comprises:
   a fifth heat exchanger mounted in the second circulation loop and in an exhaust flow circuit configured to heat the second heat transfer fluid during the circulation of the exhaust flow, and
   a sixth heat exchanger mounted in the second circulation loop and configured to heat the second heat transfer fluid during the circulation of the second fuel flow.

The use of two separate fuel circuits allows to use only a fraction of the fuel required in the combustion chamber to cool the air flows via the heat transfer fluid. It is also possible to adapt the circulation flow rate of each fuel flow to promote either a cooling of the gas turbine or a heating of the fuel.

In one embodiment, the gas turbine engine comprising an oil circuit configured to circulate a flow of lubricating oil via the compressor so as to lubricate and cool it, the flow of oil is configured to participate in heating at least one of the fuel flows while being cooled by said fuel after it has passed into the combustion chamber.

The invention also relates to an aircraft comprising at least:
a cryogenic tank,
a gas turbine engine comprising at least one compressor, a combustion chamber and a gas turbine,
a fuel circuit mounted between the cryogenic tank and the combustion chamber of the gas turbine engine, a fuel flow circulating in the fuel circuit, and
at least one cooling system for cooling the gas turbine engine as described above.

Finally, the invention relates to a method for cooling an aircraft gas turbine engine, the gas turbine engine being configured so as to be supplied by a fuel stored in a cryogenic tank and comprising, in succession along a longitudinal axis a compressor, a combustion chamber and a gas turbine, a fuel flow circulating in a fuel circuit mounted between the cryogenic tank and the combustion chamber of the gas turbine engine, the cooling method comprising the steps consisting in:
Taking a first air flow and a second air flow from the compressor of the gas turbine engine,
Respectively cooling the second air flow in a second heat exchanger and/or the first air flow in a first heat exchanger during the circulation of the heat transfer fluid, the heat transfer fluid having been initially cooled in a third heat exchanger during the circulation of the fuel flow coming from a cryogenic tank, and
Injecting at least the first air flow and/or the cooled second air flow into the gas turbine

### PRESENTATION OF THE FIGURES

The invention will be better understood on reading the following description, given by way of example, with reference to the following figures, given by way of non-limiting examples, wherein identical references are given to similar objects.

FIG. 1 is a schematic representation of a cooling system according to the prior art.

FIG. 2 is a schematic representation of a cooling system according to a first embodiment of the invention.

FIG. 3 is a schematic representation of a cooling system according to a second embodiment of the invention.

FIG. 4 is a schematic representation of a cooling system according to a third embodiment of the invention.

FIG. 5 is a schematic representation of a cooling system according to a fourth embodiment of the invention.

It should be noted that the figures set out the invention in detail in order to implement the invention, said figures of course being able to be used to better define the invention if necessary.

### DETAILED DESCRIPTION OF THE INVENTION

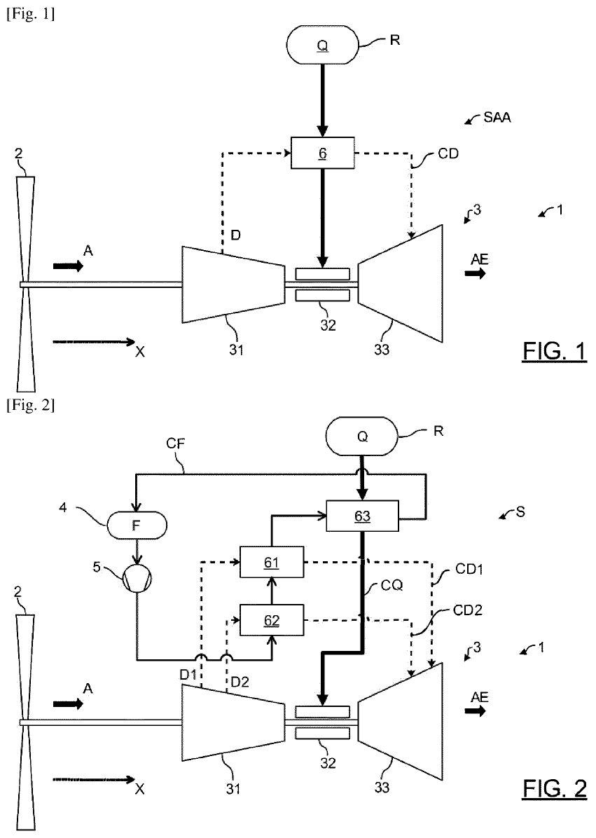

With reference to [FIG. 2], a propulsion assembly 1 configured to allow the movement of an aircraft is shown. The propulsion assembly 1 extends longitudinally along an axis X and is configured to contribute to the propulsion of the aircraft by accelerating a flow of air A circulating from upstream to downstream. The terms “upstream” and “downstream” refer to the axis X which extends from upstream to downstream of the propulsion assembly 1, as shown in [FIG. 2].

The propulsion assembly 1 comprises a fan 2 configured to rotate about the longitudinal axis X, so as to generate a flow of incoming air A to supply a gas turbine engine 3 and generate thrust as a function of a bypass ratio.

To this end, the gas turbine engine 3 comprises, successively from upstream to downstream, a compressor 31, a combustion chamber 32 and a gas turbine 33. The compressor 31 is configured to receive the incoming air flow A from the fan 2 and compress it, so as to supply the combustion chamber 32. In the combustion chamber 32, the combustion between the compressed air flow A and a fuel flow Q generates an exhaust air flow AE which drives the gas turbine 33 in rotation, thus driving the compressor 31 and the fan 2.

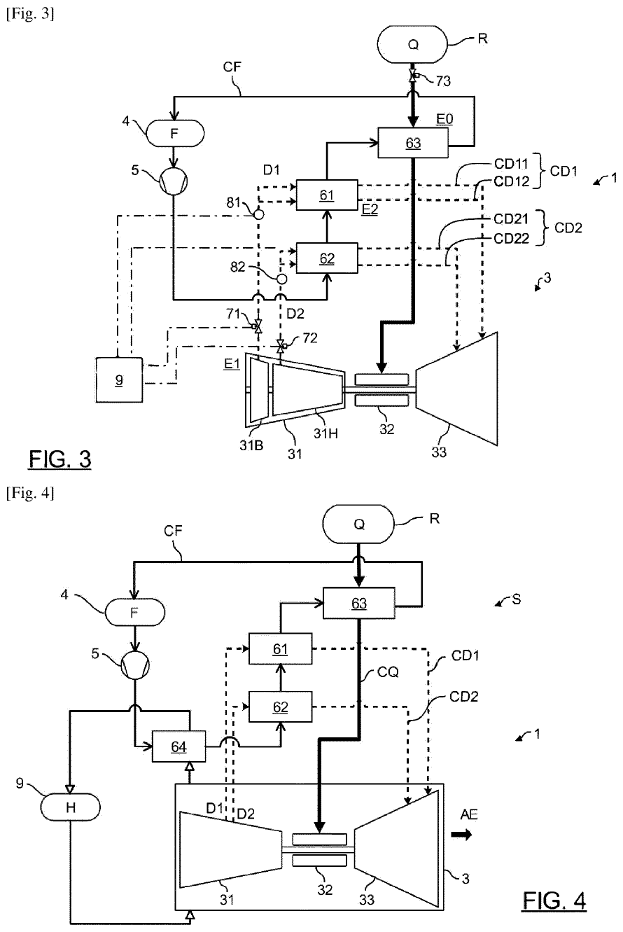

In particular, in this example, with reference to [FIG. 3], the compressor 31 comprises a low-pressure stage 31B and a high-pressure stage 31H. The low-pressure stage 31B and the high-pressure stage 31H allow the air flow A to be progressively compressed to reach a predetermined pressure ratio and allow a sufficiently compressed air flow A to be introduced into the combustion chamber 32. Such a gas turbine engine 3 is known to the person skilled in the art and its operation will not be described in greater detail in this document.

According to one aspect of the invention, the gas turbine engine 3 is configured to be supplied with fuel Q stored in a cryogenic tank R. In particular, in the cryogenic tank R, the fuel Q is stored at a temperature of the order of −253 to −251° C. (20 to 22 Kelvin). At this temperature, the fuel flow Q is liquid. In this example, the fuel Q is hydrogen, but the invention is applicable to other types of fuel, for example liquid methane or liquefied natural gas.

As shown in [FIG. 2], a fuel circuit CQ connects the cryogenic tank R to the combustion chamber 32 of the gas turbine engine 3, so as to supply it with a fuel flow Q circulating in the fuel circuit CQ.

Also shown in [FIG. 2] is a cooling system S for the gas turbine engine 3 according to one embodiment of the invention. In particular, the cooling system S is configured to cool the gas turbine 33 of the gas turbine engine 3 using a flow of air taken from the compressor 31.

To this end, the cooling system S comprises a first cooling circuit CD1 and a second cooling circuit CD2. The first cooling circuit CD1 is configured to take a first air flow D1 from the compressor 31 and inject it into the gas turbine 33. Similarly, the second cooling circuit CD2 is configured to take a second air flow D2, distinct from the first air flow D1, from the compressor 31 and inject it into the gas turbine 33.

In this example wherein the compressor 31 comprises a low-pressure stage 31B and a high-pressure stage 31H, the first air flow D1 is a low-pressure air flow from the low-pressure stage 31B and the second air flow D2 is a high-pressure air flow from the high-pressure stage 31H, as shown in [FIG. 3],

A cooling system S is shown comprising two cooling circuits CD1, CD2 mounted between the compressor 31 and the gas turbine 33, although it goes without saying that the cooling system S may comprise a different number of cooling circuits, in particular a number greater than two.

According to one aspect of the invention, with reference to FIGS. 2 and 3, the cooling system S comprises a circulation loop CF for a heat transfer fluid F. Preferably, the circulation loop CF is a closed loop wherein the heat transfer fluid F, for example nitrogen, stored in a heat transfer fluid tank 4, circulates. The use of a heat transfer fluid F allows to circulate an intermediate fluid between the fuel flow Q and the air flows D1, D2, as will be described in more detail below, advantageously eliminating any risk of contact between the fuel flow Q and the air flows D1, D2.

To allow the heat transfer fluid F to circulate, the cooling system S comprises a pump 5, preferably with a non-contact drive, for example a magnetic drive pump. Preferably, the pump 5 is configured to circulate the heat transfer fluid F at a predefined pressure and flow rate, allowing, for example, to impose a pressure in the circulation loop CF greater than the pressure of the fuel flow Q in the fuel circuit CQ. By way of example, the pressure in the circulation loop CF is greater than or equal to 3.4×106 Pa (34 bar) and the temperature is greater than or equal to −147° C. (126 K), allowing nitrogen to circulate in a supercritical state, which allows a stable flow of the heat transfer fluid F in the circulation loop CF.

To allow the first air flow D1 and the second air flow D2 to be cooled before they are introduced into the gas turbine 33, as shown in FIGS. 2 and 3, the cooling system S comprises a first heat exchanger 61, a second heat exchanger 62 and a third heat exchanger 63 mounted in the circulation loop CF for the heat transfer fluid F.

In particular, the first heat exchanger 61 is mounted both in the first cooling circuit CD1 and in the circulation loop CF and is configured to cool the first air flow D1 during the circulation of the heat transfer fluid F. In other words, the first flow D1 is configured to be cooled by frigories transferred by the previously cooled heat transfer fluid F. Similarly, the second heat exchanger 62 is mounted both in the second cooling circuit CD2 and in the circulation loop CF and is configured to cool the second air flow D2 during the circulation of the heat transfer fluid F.

The third heat exchanger 63 is mounted both in the circulation loop CF and in the fuel circuit CQ and is configured to cool the heat transfer fluid F from the circulation of the fuel flow Q coming from the cryogenic tank R. The fuel flow Q represents a major cold source which allows to cool the heat transfer fluid F, allowing the latter subsequently to cool the first air flow D1 and the second air flow D2, as will be described in more detail below. At the same time, the fuel flow Q may advantageously be heated in the air flows D1, D2 before being injected into the combustion chamber 32 of the gas turbine engine 3.

According to one aspect of the invention, the circulation loop CF is configured to circulate the heat transfer fluid F successively in the second heat exchanger 62, the first heat exchanger 61 and the third heat exchanger 63. The circulation loop CF thus allows the second air flow D2 and the first air flow D1 from the compressor 31 to be cooled successively. Thus, in the example wherein the first air flow D1 comes from the low pressure stage 31B of the compressor 31 and the second air flow D2 comes from the high pressure stage 31H, the heat transfer fluid F is configured to first cool the second air flow D2 coming from the high pressure stage 31H which is hotter than the first air flow D1 coming from the low pressure stage 31B. The higher the pressure, the higher the temperature of the air flow. In other words, the second, warmer air flow D2 leaving the compressor 31 may be cooled more effectively by the cold heat transfer fluid F. Incidentally, the first air flow D1, which is less hot than the second air flow D2, requires less frigories to be cooled and is therefore cooled by a less cold heat transfer fluid F, since it has already transferred frigories to the second air flow D2.

In an embodiment shown in [FIG. 3], the first cooling circuit CD1 comprises a first circulation duct CD11 and a second circulation duct CD12 mounted in parallel in the first cooling circuit CD1 between the compressor 31 and the turbine 33. Similarly, the second cooling circuit CD2 comprises a first circulation duct CD21 and a second circulation duct CD22 mounted in parallel in the second cooling circuit CD2 between the compressor 31 and the turbine 33 (in the embodiment shown in [FIG. 2], each cooling circuit CD1, CD2 comprises a single circulation duct). The first air flow D1 is configured to circulate either in the first circulation duct CD11 or in the second circulation duct CD12 of the first cooling circuit CD1. The second air flow D2 is configured to circulate either in the first circulation duct CD21 or in the second circulation duct CD22 of the second cooling circuit CD2. In other words, each air flow D1 preferably does not circulate simultaneously in the two cooling circuit circulation ducts CD1, CD2.

To this end, still with reference to [FIG. 3], the cooling system S preferably comprises a first controllable distribution member 71 mounted in the first cooling circuit CD1 and a second distribution member 72 mounted in the second cooling circuit CD2. The first distribution member 71 is configured to regulate the flow rate of the first air flow D1 in each of the two circulation ducts CD11, CD12. Similarly, the second distribution member 72 is configured to regulate the flow rate of the second air flow D2 in each of the two circulation ducts CD21, CD22. Preferably, each distribution member 71, 72 is mounted directly at the inlet of the first cooling circuit CD1 and the second cooling circuit CD2 respectively, so as to limit the circulation of the first air flow D1, and the second air flow D2 respectively, in one or other of the circulation ducts CD11, CD12, CD21, CD22 and therefore in each heat exchanger 61, 62 when necessary. In this example, each distribution member 71, 72 is in the form of a control valve.

The first distribution member 71 and the second distribution member 72 may preferably be controlled by a computer 9. Preferably, the computer 9 is configured to allow the first air flow D1 to circulate only in one of the two circulation ducts CD11, CD12 of the first cooling circuit CD1 and the second air flow D2 to circulate only in one of the two circulation ducts CD21, CD22 of the second cooling circuit CD2. In this way, a limited air flow rate is taken from the compressor 31 for use in the cooling system S, so that the performance of the gas turbine engine 3 is not adversely affected. Advantageously, the cooling system S has redundant circulation ducts in each cooling circuit CD1, CD2.

Still with reference to [FIG. 3], in order to monitor the state of each cooling circuit CD1, CD2, the cooling system S preferably comprises a first member 81 for measuring the flow rate of the first air flow D1 in each circulation duct CD11, CD12, CD21, CD22 of the first cooling circuit CD1 and a second member 82 for measuring the flow rate of the second air flow D2 in each circulation duct CD11, CD12, CD21, CD22 of the second cooling circuit CD2. Each measuring member 81, 82 takes the form of a flow meter, for example. In this example, the computer 9 is configured to control the first distribution member 71 and the second distribution member 72, depending on the measurement of the flow rate of each circulation duct by each flow rate measurement member 81, 82. For example, when the flow rate in one of the circulation ducts CD11, CD12, CD21, CD22 is less than an expected flow rate, indicating the presence of a leak, for example, the computer 9 is configured to stop the circulation of air flow D1, D2 in the circulation duct concerned, so as to limit any risk of damage to the gas turbine engine 3.

In one embodiment, the cooling system S comprises a member 81, 82 for measuring the flow rate upstream and downstream of each heat exchanger 61, 62, allowing to detect a leak in the heat exchanger 61, 62. The terms “upstream” and “downstream” here refer to the flow of the heat transfer fluid F in the circulation loop CF, wherein the heat transfer fluid F circulates between an outlet and an inlet of the tank 4, successively via the second heat exchanger 62, the first heat exchanger 61 and the third heat exchanger 63.

Similarly, in one embodiment, the cooling system S comprises one or more measuring members (not shown) upstream and/or downstream of the third heat exchanger 63, so as to detect, for example, a leak in the fuel circuit CQ. In this embodiment, the cooling system S comprises a distribution member 73, mounted in the fuel circuit CQ, preferably at the outlet of the cryogenic tank R, and configured to stop the circulation of the fuel flow Q in the fuel circuit CQ.

In an alternative embodiment, the cooling system S comprises one or more temperature measuring members (not shown). The computer 9 is then configured to detect a rise in temperature in each circulation duct CD11, CD12, CD21, CD22 of each cooling circuit CD1, CD2, so as to command the circulation of the air flow D1, D2 to be stopped in one of the circulation ducts CD11, CD12, CD21, CD22 which has a fault. It goes without saying that the cooling system S may just as well comprise one or more flow rate measuring members 81, 82 and one or more temperature measuring members on each cooling circuit CD1, CD2, allowing a dual monitoring to ensure that a fault is detected and thus guarantee the durability of the cooling system S and the gas turbine engine 3.

With reference to [FIG. 4], the propulsion assembly 1 also comprises an oil circuit CH configured to circulate a flow of lubricating oil H in the compressor 31 so as to lubricate and cool it. The oil circuit CH comprises an oil storage tank 9 and is configured to allow the flow of oil H to circulate in a closed loop. Such an oil circuit CH is known to the person skilled in the art and its operation will not be described in greater detail in this document.

In one example of embodiment, still referring to [FIG. 4], the cooling system S comprises a fourth heat exchanger 64, mounted in the circulation loop CF of the heat transfer fluid F and in the oil circuit CH. The fourth heat exchanger 64 is configured to cool the oil flow H during the circulation of the heat transfer fluid F. In this embodiment, the circulation loop CF is configured to circulate the heat transfer fluid F successively through the fourth heat exchanger 64, the second heat exchanger 62, the first heat exchanger 61 and the third heat exchanger 63. In this way, the oil flow H is effectively cooled by the heat transfer fluid F directly at the outlet of the pump 5.

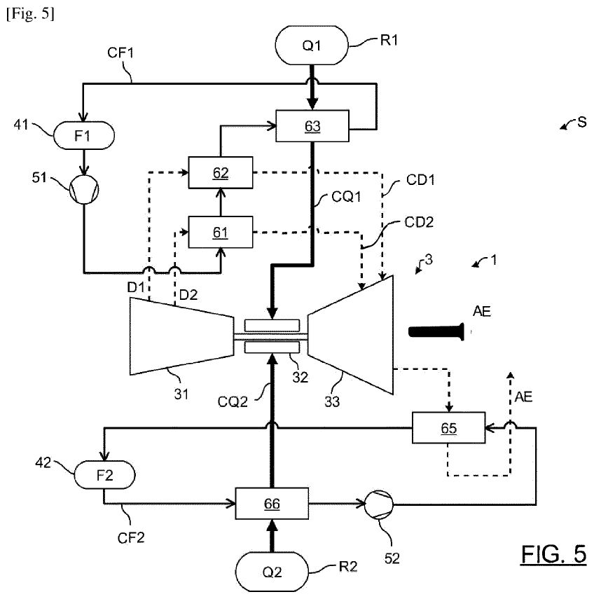

With reference to [FIG. 5], in an alternative embodiment, the gas turbine engine 3 is configured to be supplied by two separate fuel flows Q1, Q2. In particular, the gas turbine engine 3 is configured to be supplied by a first fuel flow Q1 circulating in a first fuel circuit CQ1 and by a second fuel flow Q2 circulating in a second fuel circuit CQ2. In one example, the first fuel flow Q1 and the second fuel flow Q2 are stored in the same cryogenic tank R. The first fuel circuit CQ1 and the second fuel circuit CQ2 are each connected between the cryogenic tank R and the combustion chamber 32 of the gas turbine engine 3 in order to supply it respectively with the first fuel flow Q1 and/or the second fuel flow Q2. Alternatively, as shown in [FIG. 5], the first fuel flow Q1 and the second fuel flow Q2 are stored in two separate cryogenic tanks R1, R2 mounted in the aircraft. Each fuel circuit CQ1, CQ2 is mounted respectively between each cryogenic tank R1, R2 and the combustion chamber 32 of the gas turbine engine 3.

Advantageously, the use of two fuel circuits CQ1, CQ2 allows to use only a fraction of the fuel Q required by the turbine engine 3 to ensure cooling of the gas turbine 33.

In this example, the cooling system S comprises a first circulation loop CF1 for a first heat transfer fluid F1 and a second circulation loop CF2 for a second heat transfer fluid F2, the first heat exchanger 61, the second heat exchanger 62 and the third heat exchanger 63 described above being mounted in the first circulation loop CF1. In other words, in this example, the first heat transfer fluid F1 is cooled by the first fuel flow Q1 circulating in the first fuel circuit CQ1.

In this embodiment, the cooling system S comprises a first pump 51 for circulating the first heat transfer fluid F1 (initially stored in a first cryogenic tank 41) in the first circulation loop CF1 and a second pump 52 for circulating the second heat transfer fluid F2 (initially stored in a second cryogenic tank 42) in the second circulation loop CF2.

The cooling system S also comprises a fifth heat exchanger 65 and a sixth heat exchanger 66 mounted in the second circulation loop CF2. More specifically, the fifth heat exchanger 65 is mounted both in the second circulation loop CF2 and in a circuit of the exhaust flow AE of the gas turbine 33 and is configured to heat the second heat transfer fluid F2 during the circulation of the exhaust flow AE. The sixth heat exchanger 66 is configured to heat the second heat transfer fluid F2 when the second fuel flow Q2 circulates.

This type of embodiment allows to cool the air flows D1, D2 coming from the compressor 31 by means of the first fuel flow Q1 via the first circulation loop CF1 for the first heat transfer fluid F1, while effectively heating the second fuel flow Q2 by means of the exhaust flow AE coming from the gas turbine 33 via the second circulation loop CF2 for the second heat transfer fluid F2.

The use of two fuel circuits CQ1, CQ2 with an asymmetrical architecture allows to increase robustness in order, if necessary, to adapt the circulation flow rates to promote a cooling of the gas turbine 33 or a heating of the fuel Q.

In this document is shown an alternative embodiment comprising an oil circuit H and another alternative embodiment comprising two fuel circuits CQ1, CQ2 and two circulation loops CF1, CF2 of two heat transfer fluids F1, F2 are shown herein, however, the cooling system S may alternatively comprise both two circulation loops CF1, CF2 of two heat transfer fluids F1, F2 for heating two fuel flows Q1, Q2, an oil circuit CH and a fourth heat exchanger 64, mounted both on the oil circuit CH and on one of the circulation loops CF1, CF2 of heat transfer fluids F1, F2 for cooling the oil flow H during the circulation of one of the heat transfer fluids F1, F2. The oil circuit CH may also alternatively comprise two heat exchangers to cool the oil flow H successively by means of the two circulation loops CE1, CE2 of heat transfer fluids F1, F2.

A method for cooling the gas turbine engine 3 with reference to [FIG. 3], according to one embodiment of the invention, will now be described. A fuel flow Q circulates in the fuel circuit CQ between the cryogenic tank R and the combustion chamber 32 of the gas turbine engine 3. The pump 5 allows to circulate the heat transfer fluid F in the circulation loop CF.

In a preliminary step E0, the fuel flow Q from the cryogenic tank R passes through the third heat exchanger 63, where it cools the heat transfer fluid F circulating in the circulation loop CF.

The method then comprises a first step E1 of taking the first air flow D1 and the second air flow D2 from the compressor 31 of the gas turbine engine 3, so as to circulate them respectively in the first cooling circuit CD1 and in the second cooling circuit CD2. In this example, a distribution member 71, 72 being mounted on each cooling circuit CD1, CD2, the first distribution member 71 allows the first air flow D1 to circulate in a first circulation duct CD11 of the first cooling circuit CD1 and prevents the first air flow D1 from circulating in a second circulation duct CD12 of the first cooling circuit CD1. Similarly, the second distribution member 72 allows the second air flow D2 to circulate in a first circulation duct CD21 of the second cooling circuit CD2 and prevents the second air flow D2 from circulating in the second circulation duct CD22 of the second cooling circuit CD2.

In a step E2, the heat transfer fluid F, which has been cooled by the fuel flow Q in the third heat exchanger 63, passes through the second heat exchanger 62 and then the first heat exchanger 61. The first air flow D1 circulating in the first cooling circuit CD1 is cooled in the first heat exchanger 61 by the circulation of the heat transfer fluid F.

At the outlet of the first heat exchanger 61, the first air flow D1 circulates in the first cooling circuit CD1 and is injected into the gas turbine 33 to cool it, in a step E3.

The heat transfer fluid F then passes again through the third heat exchanger 63, in a step E4, wherein it exchanges calories with the fuel flow Q. In particular, in this step, the heat transfer fluid F is cooled by cryogenic fuel Q so that it may then return to the tank 4 before cooling the first air flow D1 in the first heat exchanger 61, while the fuel flow Q is heated, so that it may be injected into the combustion chamber 32 of the gas turbine engine 3.

In one embodiment, wherein the cooling system S comprises a flow rate measuring member 81 mounted on the first cooling circuit CD1, the method comprises a step E4 of measuring the flow rate of the first air flow D1 in each circulation duct CD11, CD12 of the first cooling circuit CD1 and of comparing, by the computer 9, the measured flow rate with a predetermined flow rate threshold. When the measured flow rate is greater than the predetermined flow rate threshold, for example in the event of a leak in the first circulation duct CD11, the computer 9, in a step E5, controls the first distribution member 71 so as to prevent the first air flow D1 from circulating in the first circulation duct CD11 of the first cooling circuit CD1 and to allow the first air flow D1 to circulate in the second circulation duct CD12 of the first cooling circuit CD1. The circulation of the first air flow D1 is thus advantageously ensured thanks to the redundancy of the circulation ducts, which allows to ensure an effective cooling of the gas turbine 33.

In a similar way to steps E2 and E3, the heat transfer fluid F circulating in the circulation loop CF passes through the second heat exchanger 62 wherein it transfers frigories to the second air flow D2. At the outlet of the second heat exchanger 62, the second air flow D2 circulates in the second cooling circuit CD2 and is injected into the gas turbine 33 to cool it.

1. A cooling system for cooling a gas turbine engine for an aircraft, the gas turbine engine being configured to be supplied by a fuel stored in at least one cryogenic tank and comprising in succession along a longitudinal axis at least one compressor, a combustion chamber, and at least one gas turbine, a flow of the fuel circulating in a fuel circuit mounted between the cryogenic tank and the combustion chamber of the gas turbine engine, the cooling system comprising:
a first cooling circuit configured to take a first air flow from the at least one compressor and inject it the first air flow into the gas turbine,
a second cooling circuit configured to take a second air flow from the at least one compressor and inject the second air flow into the gas turbine,
at least one circulation loop for circulating a heat transfer fluid,
a first heat exchanger, mounted in the first cooling circuit and in the at least one circulation loop, configured to cool the first air flow during the circulation of the heat transfer fluid,
a second heat exchanger, mounted in the second cooling circuit and in the at least one circulation loop, configured to cool the second air flow during the circulation of the heat transfer fluid, and
a third heat exchanger, mounted in the at least one circulation loop, and configured to cool the heat transfer fluid from the circulation of the fuel flow,
the at least one circulation loop being configured to circulate the heat transfer fluid successively through the second heat exchanger, the first heat exchanger and the third heat exchanger.

2. The cooling system according to claim 1, wherein the at least one compressor of the gas turbine engine comprises a low-pressure stage and a high-pressure stage, configured to compress the incoming air flow to supply the combustion chamber, and wherein the first air flow is a low-pressure air flow from the low-pressure stage and the second air flow is a high-pressure air flow from the high-pressure stage.

3. The cooling system according to claim 1, wherein the first cooling circuit and the second cooling circuit each comprises a first circulation duct and a second circulation duct mounted in parallel in the first cooling circuit and in the second cooling circuit, respectively.

4. The cooling system of claim 3, wherein:
the first cooling circuit comprises a first controllable distribution member configured to regulate a flow rate of the first air flow between the first circulation duct and the second circulation duct,
the second cooling circuit comprises a second controllable distribution member configured to regulate a flow rate of the second air flow between the first circulation duct and the second circulation duct, and
wherein the cooling system further comprises a computer configured for allowing a circulation of the first air flow only in one of the first circulation duct or the second circulation duct of the first cooling circuit and a circulation of the second air flow only in one of the first circulation duct or the second circulation duct of the second cooling circuit.

5. The cooling system according to claim 1, wherein the gas turbine engine comprises an oil circuit configured to circulate a flow of lubricating oil via the at least one compressor so as to lubricate the at least one compressor, the cooling system further comprising a fourth heat exchanger, mounted in the at least one circulation loop for the heat transfer fluid and in the oil circuit, configured to cool the oil flow during the circulation of the heat transfer fluid.

6. The cooling system according to claim 1, the gas turbine engine being configured to be supplied by a first fuel flow circulating in a first fuel circuit and by a second fuel flow circulating in a second fuel circuit stored in at least one cryogenic tank, the cooling system further comprising:
at least a first circulation loop for a first heat transfer fluid and a second circulation loop for a second heat transfer fluid, the first heat exchanger, the second heat exchanger and the third heat exchanger being mounted in the first circulation loop,
a fifth heat exchanger mounted in the second circulation loop and in an exhaust flow circuit, configured to heat the second heat transfer fluid during the circulation of the exhaust flow, and
a sixth heat exchanger mounted in the second circulation loop and configured to heat the second heat transfer fluid during the circulation of the second fuel flow.

7. An aircraft comprising,
the at least one cryogenic tank,
the gas turbine engine comprising the at least one compressor, the combustion chamber, and the gas turbine,
the fuel circuit mounted between the cryogenic tank and the combustion chamber of the gas turbine engine, the fuel flow circulating in the fuel circuit, and
at least one cooling system for cooling the gas turbine engine according to claim 1.

8. A method for cooling an aircraft gas turbine engine, the aircraft gas turbine engine being configured to be supplied by a fuel stored in a cryogenic tank and comprising, in succession along a longitudinal axis, a compressor, a combustion chamber, and a gas turbine, a flow of the fuel circulating in a fuel circuit mounted between the cryogenic tank and the combustion chamber of the aircraft gas turbine engine, the cooling method comprising the steps:
taking a first air flow and a second air flow from the compressor of the aircraft gas turbine engine,
respectively cooling the second air flow in a second heat exchanger and/or the first air flow in a first heat exchanger during the circulation of the heat transfer fluid, the heat transfer fluid having been initially cooled in a third heat exchanger during the circulation of the fuel flow coming from the cryogenic tank, and
injecting at least the first air flow and/or the cooled second air flow into the aircraft gas turbine.
